(19) United States
(12) Patent Application Publication
(10) Pub. No.: US 2026/0288873 A1
(43) Pub. Date: Sep. 24, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Kazuhiro HATAKEDA, Tokyo (JP); Koji TSUKAMOTO, Tokyo (JP); Takahiro ISHIKAWA, Tokyo (JP)

(21) Appl. No.: 19/558,028

(22) Filed: Mar. 5, 2026

(30) Foreign Application Priority Data
Mar. 19, 2025 (JP) 2025-044785

(51) Int. Cl. G06F 16/903

(52) U.S. Cl. CPC G06F 16/90335

(57) ABSTRACT

An information processing apparatus according to the present application includes a reception unit, a search unit, and a generation unit. The reception unit receives a request from a first user. The search unit searches for information for generating a response to a request from the first user based on a relationship between a characteristic of a second user and whether or not a specific action related to a response to a past request from the second user is performed by the second user after provision of the response. The generation unit generates a response to a request from the first user based on a search result that is obtained by the search unit and the request from the first user.

### CROSS-REFERENCE TO RELATED APPLICATIONS

The present application claims priority to and incorporates by reference the entire contents of Japanese Patent Application No. 2025-044785 filed in Japan on Mar. 19, 2025.

### BACKGROUND OF THE INVENTION

### 1. Field of the Invention

The present invention is related to an information processing apparatus, an information processing method, and a non-transitory computer readable storage medium.

### 2. Description of the Related Art

In recent years, services for sharing information among users via a network, such as the Internet, are becoming popular. In this kind of services, for example, knowledge and wisdom are shared among users in such a manner that a certain user (questioner) posts a question and another user (answerer) posts an answer to the question (for example, Japanese Laid-open Patent Publication No. 2019-125146). Further, Japanese Patent Publication No. 7509972 proposes a technology for generating an answer to a question by using AI.

However, in the conventional technology, only an answer to a question is provided to a user, and an action of the user to whom the answer is provided is not paid attention to; therefore, there is room for improvement in this respect. This is not limited to a question, and the same applies to an action of the user to whom a response to a request other than a question is provided.

### SUMMARY OF THE INVENTION

An information processing apparatus according to the present application includes a reception unit, a search unit, and a generation unit. The reception unit receives a request from a first user. The search unit searches for information for generating a response to a request from the first user based on a relationship between a characteristic of a second user and whether or not a specific action related to a response to a past request from the second user is performed by the second user after provision of the response. The generation unit generates a response to a request from the first user based on a search result that is obtained by the search unit and the request from the first user.

It should be noted that some or all of the above-described means for solving the problem may be implemented using various artificial intelligence-related technologies and techniques, including, but not limited to, the use of various generative AI models implemented using machine learning, deep learning, large language models, and the like.

### BRIEF DESCRIPTION OF THE DRAWINGS

FIG. 1 is a diagram illustrating an example of information processing according to one embodiment;

FIG. 2 is a diagram illustrating an example of a configuration of an information processing system according to one embodiment;

FIG. 3 is a diagram illustrating an example of a configuration of an information processing apparatus according to one embodiment;

FIG. 4 is a diagram illustrating an example of a user information table that is stored in a user information storage unit of the information processing apparatus according to one embodiment;

FIG. 5 is a diagram illustrating an example of a request related information table that is stored in a request related information storage unit of the information processing apparatus according to one embodiment;

FIG. 6 is a diagram illustrating an example of an action-after-provision information table that is stored in an action-after-provision information storage unit of the information processing apparatus according to one embodiment;

FIG. 7 is a diagram illustrating an example of a specific relationship information table that is stored in a specific relationship information storage unit of the information processing apparatus according to one embodiment;

FIG. 8 is a flowchart illustrating an example of information processing that is performed by a processing unit of the information processing apparatus according to one embodiment;

FIG. 9 is a flowchart illustrating an example of a response providing process that is performed by the processing unit of the information processing apparatus according to one embodiment;

FIG. 10 is a flowchart illustrating an example of a specific relationship determination process that is performed by the processing unit of the information processing apparatus according to one embodiment; and

FIG. 11 is a hardware configuration diagram illustrating an example of a computer that implements functions of the information processing apparatus according to one embodiment.

### DETAILED DESCRIPTION OF THE PREFERRED EMBODIMENTS

Modes (hereinafter, described as “embodiments”) for carrying out an information processing apparatus, an information processing method, and a non-transitory computer readable storage medium according to the present application will be described in detail below with reference to the drawings. Meanwhile, the information processing apparatus, the information processing method, and the non-transitory computer readable storage medium are not limited by the embodiments below. Further, embodiments may be combined appropriately as long as processes do not conflict with each other. Furthermore, in the embodiments described below, the same components are denoted by the same reference symbols, and repeated explanation will be omitted.

### 1. Example of Information Processing

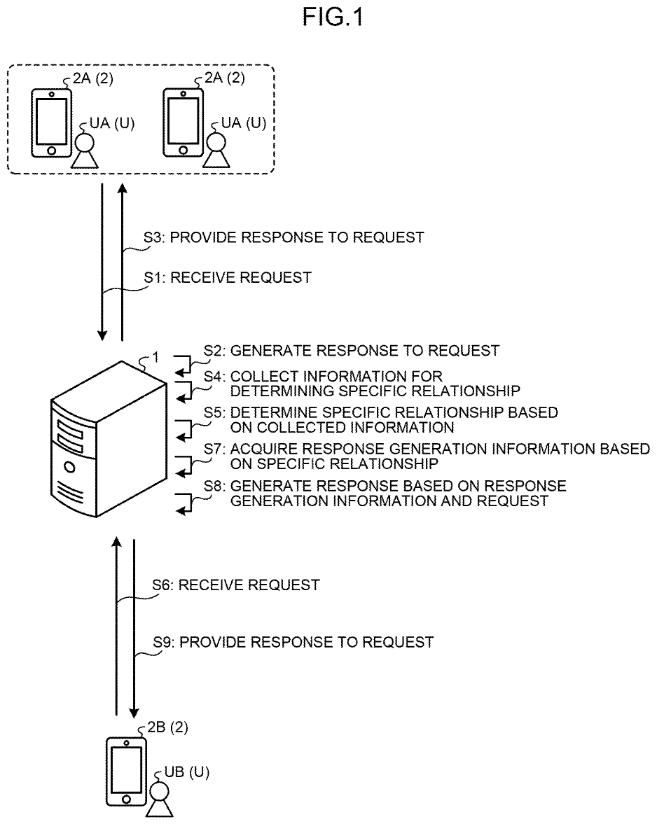

An example of information processing according to one embodiment will be described below with reference to FIG. 1. FIG. 1 is a diagram illustrating an example of the information processing according to one embodiment.

An information processing apparatus 1 illustrated in FIG. 1 is an information processing apparatus that cooperates with terminal apparatuses 2 of users U, provides various kinds of information online to the users U, and is implemented by, for example, one or more servers, cloud system, or the like.

In the example illustrated in FIG. 1, the plurality of terminal apparatuses 2 are illustrated, and the information processing apparatus 1 cooperates with each of the terminal apparatuses 2 and provides various kinds of services online to the user U of each of the terminal apparatuses 2. In the following, for the sake of convenience, the users U may be separately described as a user UA and a user UB. The user UA is one example of a second user or a user, and the user UB is one example of a first user or a different user. Further, the terminal apparatus 2 of the user UA may be described as a terminal apparatus 2A, and the terminal apparatus 2 of the user UB may be described as a terminal apparatus 2B. Meanwhile, the user U may be read as both of the user UA and the user UB.

A service that is provided online by the information processing apparatus 1 to the user U is, for example, a Q&A (question & answer) service, an electronic commerce service, a Social Networking Service (SNS), or the like, but embodiments are not limited to this example.

The Q&A service receives a question that is posted by a questioner, and makes the received question public. Further, the Q&A service receives an answer that is posted by an answerer with respect to the posted question, and makes the received answer public. The user U can be both of the questioner and the answerer. The electronic commerce service is, for example, a shopping service, a flea market service, an auction service, or the like, but embodiments are not limited to this example.

The information processing apparatus 1 receives a request from the user UA (Step S1). The request from the user UA includes, for example, a question in an online service (for example, a question in the Q&A service, a question about a product in the electronic commerce service, or the like), a post or a reply in an SNS, or the like, but embodiments are not limited to this example.

The user UA is able to cause, by operating the terminal apparatus 2A, the terminal apparatus 2A to perform a process of transmitting information including a request from the user UA to the information processing apparatus 1. The information processing apparatus 1 receives the request from the user UA by receiving the request information from the terminal apparatus 2A.

The information processing apparatus 1 generates a response to the request that is received from the user UA at Step S1 (Step S2). The information processing apparatus 1 generates, by using generative AI, the response to the request that is received from the user UA at Step S1. The response to the request from the user UA includes, for example, information indicating a proposal to the user UA, but embodiments are not limited to this example.

For example, the information processing apparatus 1 generates, by using generative AI, a search query for searching for information for generating the response to the request from the user UA. The information processing apparatus 1 searches for, by using the generated search query, the information for generating the response to the request from the user from, for example, an external apparatus, an internal database, or the like. The information processing apparatus 1 generates, by using generative AI, the response to the request that is received from the user UA at Step S1, based on the request that is received from the user UA at Step S1 and a result of search using the search query.

The information processing apparatus 1 provides the response that is generated at Step S2 to the user UA (Step S3). For example, the information processing apparatus 1 provides the response that is generated at Step S2 to the user UA by transmitting response information including the response that is generated at Step S2 to the terminal apparatus 2A.

The information processing apparatus 1 performs the processes at Step S2 and Step S3 with respect to each of requests from the plurality of users UA. The generative AI as described above is, for example, a Large Language Model (LLM) or the like, and is text-to-text generative AI that receives input of text and outputs text, but embodiments are not limited to this example. For example, the generative AI may be multimodal generative AI that is able to receive input of text and an image and output text and an image.

Subsequently, the information processing apparatus 1 collects action-after-provision information that is information for determining a specific relationship, for each of the responses that are provided at Step S3, from an information providing apparatus (not illustrated) or the like (Step S4). The specific relationship is a relationship between a characteristic of the user UA and whether or not a certain specific action (hereinafter may be described as a specific action) related to the response is performed by the user UA after the response is provided to the user UA at Step S3.

The action-after-provision information is, for example, information indicating an action of the user UA to which the response is provided at Step S3, and includes, for example, a user Identifier (ID) of the user UA and information indicating an action of the user UA after provision of the response. The information processing apparatus 1 determines whether or not the user UA has performed the specific action based on the collected action-after-provision information.

The specific action is an action that is determined in advance, and is, for example, a conversion with respect to the response. For example, when the response to the request from the user UA includes information indicating a proposal of a specific target, the specific action is, for example, a conversion related to the specific target. The specific target is, for example, a product, a service, or the like, but embodiments are not limited to this example. A proposal target is one example of the specific target. When the specific target is a specific product, the specific action is, for example, a specific action related to the specific product.

The action related to the product is, for example, a search using a name of the specific product as a search keyword, browsing of a web page that introduces the specific product, a post related to the specific product (for example, a question related to the specific product), browsing of a web page that sells the specific product, or a purchase of the specific product, but embodiments are not limited to this example.

The information processing apparatus 1 determines a specific relationship based on the information that is collected at Step S4 (Step S5). For example, the information processing apparatus 1 determines, as the specific relationship, an implementation rate (for example, a conversion rate) of the specific action for each characteristic of the user UA, based on relationship determination information and information on the user UA (for example, the request from the user UA, an attribute of the user UA, or the like).

The characteristic of the user UA is represented by, for example, a single class among a plurality of classes that are obtained by clustering requests from the plurality of users UA. The clustering is performed by using, for example, vectors that are obtained by vectorizing the requests from the plurality of users UA, but embodiments are not limited to this example. Further, the characteristic of the user UA may be represented by the attribute of the user UA. Furthermore, the characteristic of the user UA may be represented by a combination of the class of the request and the attribute of the user UA. In this manner, the information processing apparatus 1 is able to determine the characteristic of the user UA based on one or both of the request from the user UA and the attribute of the user UA.

Moreover, the information processing apparatus 1 may determine the specific relationship by determining the characteristic of the user UA and implementation or non-implementation of the specific action, based on the relationship determination information and the information on the user UA. In this case, the information processing apparatus 1 associates the characteristic of the user UA and implementation or non-implementation of the specific action with each of the users UA.

In this case, the characteristic of the user UA is represented by a vector that is obtained by vectorizing the request from the user UA. Furthermore, the characteristic of the user UA may be represented by a vector that is obtained by vectorizing the attribute of the user UA. Moreover, the characteristic of the user UA may be represented by a combination of the vector that is obtained by vectorizing the request from the user UA and the vector that is obtained by vectorizing the attribute of the user UA.

Subsequently, the information processing apparatus 1 receives a request from the user UB (Step S6). The request from the user UB is, similarly to the request from the user UA, for example, a question in an online service, a post or a reply in an SNS, or the like, but embodiments are not limited to this example.

The user UB is able to cause, by operating the terminal apparatus 2B, the terminal apparatus 2B to perform a process of transmitting information including a request from the user UB to the information processing apparatus 1. The information processing apparatus 1 receives the request from the user UB by receiving the request information from the terminal apparatus 2B.

The information processing apparatus 1 acquires response generation information that is information for generating a response to the request from the user UB, based on a characteristic of the user UB and information indicating the specific relationship as described above (Step S7). For example, the information processing apparatus 1 generates a search query for searching for the response generation information based on the characteristic of the user UB and specific relationship information.

The search query includes, for example, a search keyword for searching for a web page related to a specific target, a search keyword for searching for a web page for taking a specific action, or the like, but embodiments are not limited to this example.

The information processing apparatus 1 searches for and acquires the response generation information by using the generated search query. For example, the information processing apparatus 1 searches for, by using the generated search query, the response generation information from, for example, an external apparatus, an internal database, or the like.

Here, it is assumed that the implementation rate of the specific action for each characteristic of the user UA is determined at Step S5. In this case, the information processing apparatus 1 searches for, as the response generation information, information on a specific target corresponding to a specific action for which the implementation rate associated with the characteristic of the user UB is the highest. The information processing apparatus 1 determines the characteristic of the user UB based on one or both of the request from the user UB and an attribute of the user UB.

Furthermore, it is assumed that implementation or non-implementation of the specific action for each characteristic of the user UA is determined at Step S5. In this case, the information processing apparatus 1 searches for, as the response generation information, information on a specific target corresponding to an implemented specific action (or a specific action with a higher implementation rate) among specific actions that are associated with characteristics similar to the characteristic of the user UB, based on implementation and non-implementation of the specific actions that are associated with the characteristics similar to the characteristic of the user UB.

Subsequently, the information processing apparatus 1 generates, by using generative AI, a response to the request that is received from the user UB at Step S6, based on the response generation information that is acquired at Step S7 and the request that is received from the user UB at Step S6 (Step S8).

For example, the information processing apparatus 1 generates, by using generative AI, input information (prompt) that includes an instruction text including an instruction text for generating a response to the request from the user UB by using the response generation information, the request from the user UB, and the response generation information. The information processing apparatus 1 is able to cause the generative AI to generate the response to the request from the user UB by inputting the generated input information (prompt) to the generative AI.

Subsequently, the information processing apparatus 1 provides the response that is generated at Step S8 to the user UB (Step S9). For example, the information processing apparatus 1 provides the response that is generated at Step S8 to the user UB by transmitting response information including the response that is generated at Step S8 to the terminal apparatus 2B.

In this manner, the information processing apparatus 1 searches for the information for generating the response to the request from the user, and provides the response that is generated based on a search result to the user UA. Further, the information processing apparatus 1 collects information for determining a relationship between the characteristic of the user UA and whether or not a specific action related to the response is performed by the user UA after the response is provided to the user UA. With this configuration, the information processing apparatus 1 is able to use the action of the user UA to which the response to the request is provided.

Furthermore, the information processing apparatus 1 receives a request from the user UB, and searches for information for generating a response to the request from the user UB based on a relationship between the characteristic of the user UA and whether or not an action related to the response is performed by the user UA after a response to a past request from the user UA is provided. Moreover, the information processing apparatus 1 generates the response to the request from the user UB based on a search result and the request from the user UB. With this configuration, the information processing apparatus 1 is able to use the action of the user UA to which the response to the request is provided.

A configuration of an information processing system that includes the information processing apparatus 1 and the terminal apparatus 2 that perform the processes as described above will be described in detail below.

### 2. Configuration of Information Processing System

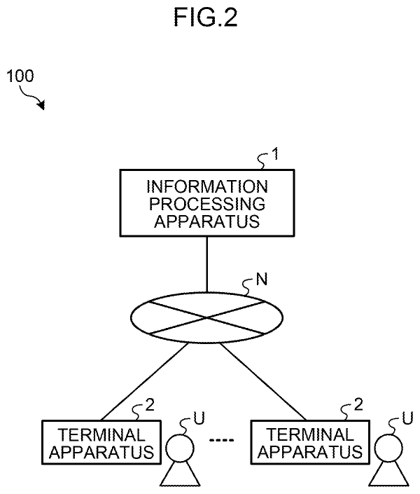

FIG. 2 is a diagram illustrating an example of a configuration of the information processing system according to one embodiment. As illustrated in FIG. 2, an information processing system 100 according to one embodiment includes the information processing apparatus 1 and the plurality of terminal apparatuses 2.

The plurality of terminal apparatuses 2 are used by the different users U. The terminal apparatus 2 is, for example, a notebook Personal Computer (PC), a desktop PC, a smartphone, a tablet PC, or a wearable device. The wearable device is, for example, smart glasses, a smart watch, or the like, but embodiments are not limited to this example.

The information processing apparatus 1 and each of the terminal apparatuses 2 are communicably connected to each other in a wired or wireless manner via a network N. Meanwhile, the information processing system 100 illustrated in FIG. 2 may include the plurality of information processing apparatuses 1 or the like.

The network N includes, for example, a mobile communication network, such as a Wide Area Network (WAN) including the Internet or the like, Long Term Evolution (LTE), 4th Generation (4G), or 5th Generation (5G: 5th generation mobile communication system), but embodiments are not limited to this example.

The terminal apparatus 2 is able to connect to the network N via the mobile communication network or near field communication, such as Bluetooth (registered trademark) or a wireless Local Area Network (LAN), and communicate with the information processing apparatus 1 or the like.

### 3. Configuration of Information Processing Apparatus 1

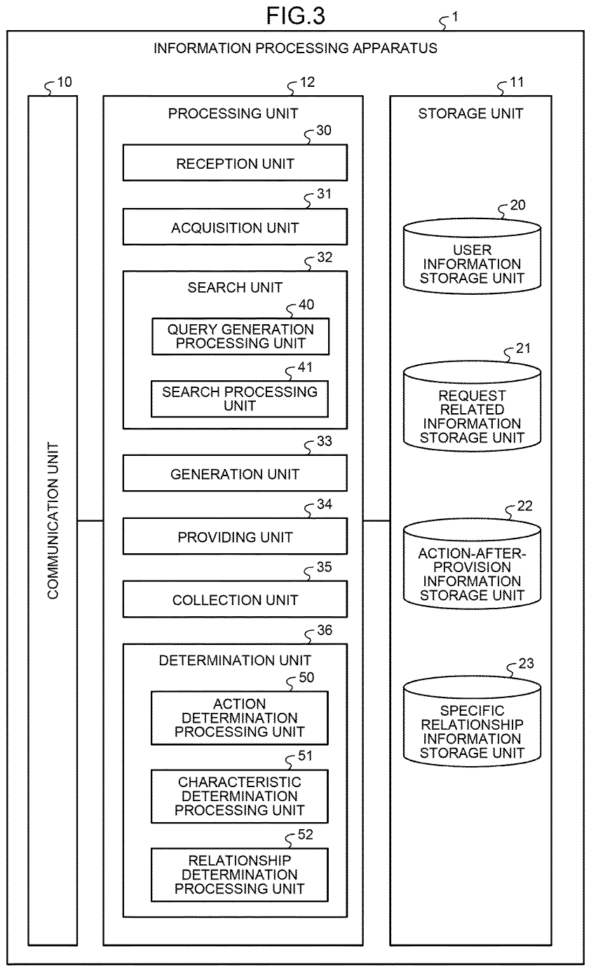

FIG. 3 is a diagram illustrating an example of a configuration of the information processing apparatus 1 according to one embodiment. As illustrated in FIG. 3, the information processing apparatus 1 includes a communication unit 10, a storage unit 11, and a processing unit 12.

### 3.1. Communication Unit 10

The communication unit 10 is implemented by, for example, a communication module, a Network Interface Card (NIC), or the like. Further, the communication unit 10 is connected to the network N in a wired or wireless manner, and transmits and receives information to and from various kinds of other apparatuses. For example, the communication unit 10 transmits and receives information to and from the terminal apparatus 2 via the network N.

### 3.2. Storage Unit 11

The storage unit 11 is implemented by, for example, a semiconductor memory device, such as a Random Access Memory (RAM) or a flash memory, or a storage device, such as a hard disk or an optical disk. The storage unit 11 includes a user information storage unit 20, a request related information storage unit 21, an action-after-provision information storage unit 22, and a specific relationship information storage unit 23.

### 3.2.1. User Information Storage Unit 20

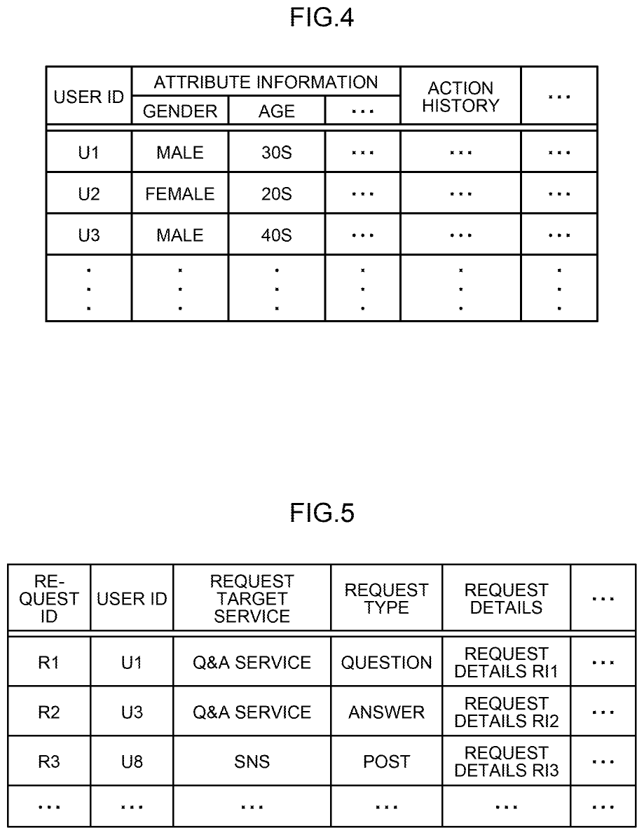

The user information storage unit 20 stores therein user information including information on the user U. FIG. 4 is a diagram illustrating an example of a user information table that is stored in the user information storage unit 20 of the information processing apparatus 1 according to one embodiment. As illustrated in FIG. 4, the user information table that is stored in the user information storage unit 20 includes items such as a “user ID”, “attribute information”, and an “action history”.

The “user ID” is identification information for identifying the user U. The “attribute information” is attribute information on the user U corresponding to the “user ID”, and includes, for example, information on a psychographic attribute, information on a demographic attribute, or the like. The demographic attribute is, for example, gender, age, an area of residence, an occupation, or the like, and the psychographic attribute is a subject of interest, such as travel, clothes, cars, or a religion, a lifestyle, a philosophy, an ideology, or the like.

The “action history” is an action history of the user U corresponding to the “user ID”. The action history of the user U is an action history of the user U in online services and an action history of the user U in offline services. The action history of the user U in online services includes, for example, information on a search history, a browsing history, a post history, a purchase history, or the like.

### 3.2.2. Request Related Information Storage Unit 21

The request related information storage unit 21 stores therein request related information that is information on a request from the user U. FIG. 5 is a diagram illustrating an example of a request related information table that is stored in the request related information storage unit 21 of the information processing apparatus 1 according to one embodiment. As illustrated in FIG. 5, the request related information table that is stored in the request related information storage unit 21 includes items such as a “request ID”, the “user ID”, a “request target service”, a “request type”, and “request information”.

The “request ID” is identification information for identifying a request. The “user ID” is a user ID of the user U who has issued the request corresponding to the “request ID”. The “request target service” includes information indicating a type of an online service for which the request corresponding to the “request ID” is issued.

The “request type” includes information indicating a type of the request corresponding to the “request ID”. The type of the request is, for example, a question, an answer, or the like when the online service is a Q&A service, and a post, a reply, or the like when the online service is an SNS. The “request information” includes information indicating details of the request corresponding to the “request ID”. 3.2.3. Action-After-Provision Information Storage Unit 22

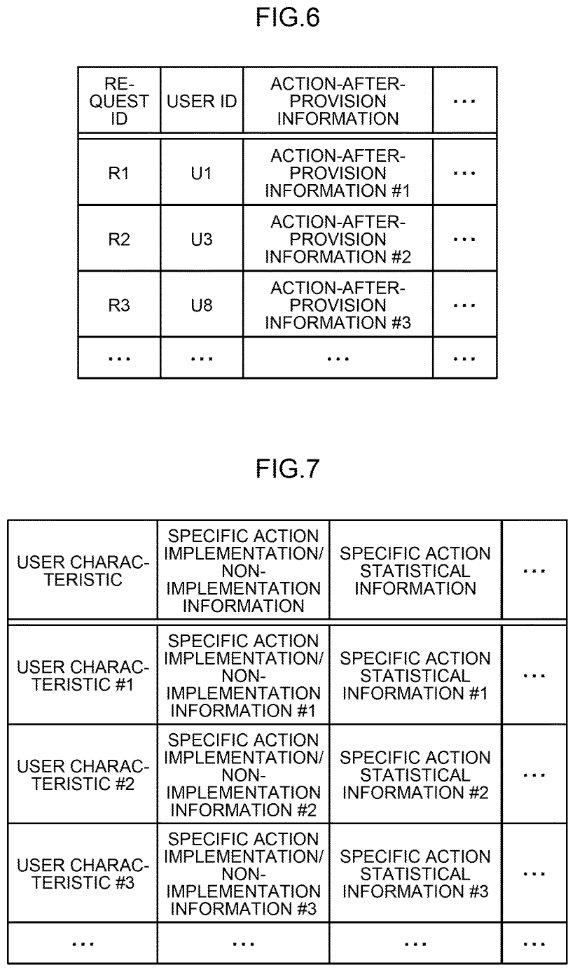

The action-after-provision information storage unit 22 stores therein action-after-provision information that indicates an action of the user U after the response to the request from the user U is provided. FIG. 6 is a diagram illustrating an example of an action-after-provision information table that is stored in the action-after-provision information storage unit 22 of the information processing apparatus 1 according to one embodiment. As illustrated in FIG. 6, the action-after-provision information table that is stored in the action-after-provision information storage unit 22 includes items such as the “request ID”, the “user ID”, and “action-after-provision information”.

The “request ID” is identification information for identifying a request. The “user ID” is a user ID of the user U who has issued the request corresponding to the “request ID”. The “action-after-provision information” is action-after-provision information on the user U who has issued the request corresponding to the “request ID”. The action-after-provision information is information indicating an action that is taken by the user U after the response to the request from the user U is provided. The action-after-provision information may include information indicating a date and time of the action of the user U.

### 3.2.4. Specific Relationship Information Storage Unit 23

The specific relationship information storage unit 23 stores therein specific relationship information that is information indicating a specific relationship. FIG. 7 is a diagram illustrating an example of a specific relationship information table that is stored in the specific relationship information storage unit 23 of the information processing apparatus 1 according to one embodiment. As illustrated in FIG. 7, the specific relationship information table that is stored in the specific relationship information storage unit 23 includes items such as a “user characteristic”, “specific action implementation/non-implementation information”, and “specific action statistical information”.

The “user characteristic” is information that indicates a characteristic of the user U. The “specific action implementation/non-implementation information” is information that corresponds to the characteristic of the user U and includes information indicating whether or not the user U has performed the specific action. The “specific action statistical information” is information that corresponds to the characteristic of the user U and includes information indicating an implementation rate (for example, a conversion rate) of the specific action taken by the user U.

### 3.3. Processing Unit 12

The processing unit 12 is a controller, and implemented by, for example, causing a processor, such as a Central Processing Unit (CPU) or a Micro Processing Unit (MPU), to execute various kinds of programs (corresponding to one example of an information processing program) that are stored in a storage device inside the information processing apparatus 1 by using a RAM or the like as a work area.

Further, the processing unit 12 is a controller, and a part or whole of the processing unit 12 may be implemented by, for example, an integrated circuit, such as an Application Specific Integrated Circuit (ASIC), a Field Programmable Gate Array (FPGA), or a General Purpose Graphic Processing Unit (GPGPU).

As illustrated in FIG. 3, the processing unit 12 includes a reception unit 30, an acquisition unit 31, a search unit 32, a generation unit 33, a providing unit 34, a collection unit 35, and a determination unit 36, and implements or executes functions and operation of information processing as described below. Meanwhile, an internal configuration of the processing unit 12 is not limited to the configuration as illustrated in FIG. 3, and a different configuration may be adopted as long as the information processing to be described below is performed.

### 3.3.1. Reception Unit 30

The reception unit 30 receives various kinds of information and requests. For example, the reception unit 30 receives a request from the user U, where the request is transmitted from the terminal apparatus 2 or the like. The user U corresponding to the request is one example of a first user or a user.

The request from the user U includes, for example, a question in an online service (for example, a question in the Q&A service, a question about a product in the electronic commerce service, or the like), a post or a reply in an SNS, or the like, but embodiments are not limited to this example.

### 3.3.2. Acquisition Unit 31

The acquisition unit 31 acquires various kinds of information from an external apparatus (for example, an external information providing apparatus or the terminal apparatus 2) or the storage unit 11. For example, the acquisition unit 31 acquires the user information or the like from an external apparatus, and stores the acquired user information or the like in the storage unit 11.

Further, the acquisition unit 31 acquires, for example, the user information, the request related information, the action-after-provision information, and the specific relationship information from the storage unit 11.

### 3.3.3. Search Unit 32

The search unit 32 searches for information for generating a response to the request from the user U. For example, the search unit 32 searches for, by using generative AI, the information for generating the response to the request from the user U. The response to the request from the user UA includes, for example, information indicating a proposal to the user UA, but embodiments are not limited to this example.

The search unit 32 includes a query generation processing unit 40 and a search processing unit 41. The query generation processing unit 40 generates, by using generative AI, a search query corresponding to the request from the user U.

The query generation processing unit 40 is able to generate a search query for searching for the information for generating the response to the request from the user U, which is received by the reception unit 30, based on, for example, the characteristic of the user U corresponding to the request that is received by the reception unit 30 and the specific relationship information that is information indicating a specific relationship.

The specific relationship indicated by the specific relationship information is, as described above, a relationship between the characteristic of the user U and whether or not the specific action that is a certain specific action related to the response is performed by the user U after a response to a past request from the user U is provided.

For example, it is assumed that the specific relationship information includes an implementation rate of the specific action for each characteristic of the user U. In this case, the query generation processing unit 40 generates a search query for searching for information on a specific target corresponding to top m specific actions (m is an integer equal to or larger than two) with the highest implementation rates that are associated, as the specific relationship, with the characteristic of the user U whose request is received by the reception unit 30. The query generation processing unit 40 determines the characteristic of the user U based on one or both of the request from the user U and the attribute of the user U.

In this case, the query generation processing unit 40 is able to generate input information (prompt) that includes, for example, the request from the user U, information indicating the top m specific actions with the highest implementation rates that are associated, as the specific relationship, with the characteristic of the user U whose request is received by the reception unit 30, and instruction information that is information on a specific target corresponding to the top m specific actions and includes an instruction text for instructing generation of a search query that is used for searching for information for generating a response to the request from the user U. The query generation processing unit 40 inputs the generated input information (prompt) to generative AI, and causes the generative AI to generate a search query.

Furthermore, it is assumed that the specific relationship information includes information indicating implementation or non-implementation of the specific action for each characteristic of the user U. In this case, the query generation processing unit 40 generates a search query for searching for information on a specific target corresponding to a specific action with a high implementation rate among specific actions that are associated with the same characteristic as or a similar characteristic to the characteristic of the user U whose request is received by the reception unit 30, based on implementation or non-implementation of n or more specific actions (n is an integer equal to or larger than one) that are associated, as the specific relationship, with the same characteristic as or a similar characteristic to the characteristic of the user U whose request is received by the reception unit 30.

In this case, the query generation processing unit 40 is able to generate input information (prompt) that includes, for example, the request from the user U, information indicating implementation of n or more specific actions that are associated, as the specific relationship, with the same characteristic as or a similar characteristic to the characteristic of the user U whose request is received by the reception unit 30 (excluding information indicating non-implementation), and instruction information that is information on a specific target corresponding to the implemented action among the n or more specific actions and includes an instruction text for instructing generation of a search query that is used for searching for information for generating a response to the request from the user U. The query generation processing unit 40 inputs the generated input information (prompt) to generative AI, and causes the generative AI to generate a search query.

The search query is information that includes one or more search keywords, but may be information that includes a search text instead of one or more search keywords. Meanwhile, the query generation processing unit 40 may extract one or more search keywords from the request from the user U based on rules instead of the generative AI, and generate a search query that includes the one or more extracted search keywords. Further, the query generation processing unit 40 may generate the request from the user U as it is as a search query.

In this manner, the query generation processing unit 40 generates a search query for searching for the response generation information that is information for generating a response to the request from the user U based on, for example, the specific relationship. The search query that is generated by the query generation processing unit 40 includes, for example, a search keyword for searching for a web page related to a specific target, a search keyword for searching for a web page for performing a specific action, or the like, but embodiments are not limited to this example.

The search processing unit 41 searches for the response generation information that is the information for generating a response to the request from the user U whose request is received by the reception unit 30, by using the search query that is generated by the query generation processing unit 40. For example, the search processing unit 41 searches for the response generation information from, for example, an external apparatus, an internal database, or the like by using the search query that is generated by the query generation processing unit 40. Meanwhile, search performed by the search processing unit 41 is a keyword search or a vector search, but embodiments are not limited to this example.

### 3.3.4. Generation Unit 33

The generation unit 33 generates various kinds of information. For example, the generation unit 33 generates a response to the request from the user U whose request is received by the reception unit 30, based on a search result that is obtained by the search unit 32.

The generation unit 33 generates, for example, by using generative AI, a response to the request from the user U whose request is received by the reception unit 30. For example, the generation unit 33 is able to cause generative AI to generate a response to the request from the user U based on input information (prompt) that includes the request from the user U, the response generation information that is the search result obtained by the search unit 32, and instruction information that includes an instruction text for instructing generation of the response to the request from the user U by using the response generation information.

When the request from the user U is a question, the response to the request from the user U is an answer to the question. For example, it is assumed that the question from the user U is “I want to purchase a watch to wear to a dinner with an important client. What watch do you recommend?”, and the response generation information is information on a watch A and a watch B. In this case, the response is, for example, “You are considering purchase of a watch to wear to a dinner with an important client. We recommend the following watches. 1. Watch A: this watch is . . . , 2. Watch B: this watch is . . . ”, or the like. In this case, the response includes, as information indicating a proposal to the user U, the information on the watch A and the watch B.

Furthermore, it is assumed that the question from the user U is “What coffee maker do you recommend for enjoying authentic coffee at home?”, and the response generation information is information on a coffee maker D. In this case, the response is, for example, “Coffee maker D is a full-automatic coffee maker that can easily make espresso and cappuccino. It is popular among many users and easy to use”, or the like. In this case, the response includes, as the information indicating a proposal to the user U, the information on the coffee maker D.

In this manner, the generation unit 33 is able to generate a response to the request from the user U based on the search result obtained by the search unit 32 and the request from the user U. In the example described above, the generation unit 33 generates the response to the request from the user U by using generative AI, but it may be possible to generate the response to the request from the user U based on rules.

### 3.3.5. Providing Unit 34

The providing unit 34 provides various kinds of information to the user U. For example, the providing unit 34 provides various kinds of information to the user U by transmitting the various kinds of information to the terminal apparatus 2 of the user U.

The providing unit 34 provides, for example, the response that is generated by the generation unit 33 to the user U. For example, the providing unit 34 provides the response that is generated by the generation unit 33 to the user U by providing, in an online service, the response that is generated by the generation unit 33. The response that is generated by the generation unit 33 is provided to the user U by being associated with, for example, the request from the user U.

For example, it is assumed that the request from the user U is a question in an online service. In this case, the providing unit 34 is able to provide an answer to the question from the user U to the user U by publishing, in an online service, the question from the user U in the online service and the answer to the question in an associated manner.

Furthermore, the providing unit 34 is able to provide information including the question from the user U in the online service and the answer to the question to the user U via an electronic mail or a dedicated application.

### 3.3.6. Collection Unit 35

The collection unit 35 collects various kinds of information. For example, the collection unit 35 collects the action-after-provision information that is information for determining a specific relationship from an external apparatus or the like. The collection unit 35 stores the collected action-after-provision information in the storage unit 11. The specific relationship is a relationship between the characteristic of the user U and whether or not a specific action related to the response is performed by the user UA after the response is provided to the user UA by the providing unit 34.

For example, the collection unit 35 collects the action-after-provision information that indicates an action that is performed by the user U after the providing unit 34 provides the response to the user U. The action-after-provision information includes, for example, the user ID of the user U and information indicating an action that is performed by the user U after provision of the response, but embodiments are not limited to this example.

The action-after-provision information includes information for determining whether or not a specific action related to the response is performed by the user U after the providing unit 34 provides the response to the user U, but may include different information.

The specific action is an action that is determined in advance, and is, for example, a conversion with respect to the response. For example, when the response to the request from the user U includes information indicating a proposal of a specific target, the specific action is, for example, a conversion related to the specific target. The specific target is, for example, a product, a service, or the like, but embodiments are not limited to this example. A proposal target is one example of the specific target. When the specific target is a specific product, the specific action is, for example, a specific action related to the specific product.

The action related to the product is, for example, a search using a name of the specific product as a search keyword, browsing of a web page that introduces the specific product, a post related to the specific product (for example, a question related to the specific product), browsing of a web page that sells the specific product, or a purchase of the specific product, but embodiments are not limited to this example.

### 3.3.7. Determination Unit 36

The determination unit 36 performs various kinds of determination. For example, the determination unit 36 determines a specific relationship based on the information that is collected by the collection unit 35. The determination unit 36 stores information indicating the determined specific relationship, as the specific relationship information, in the storage unit 11.

The determination unit 36 includes an action determination processing unit 50, a characteristic determination processing unit 51, and a relationship determination processing unit 52. The action determination processing unit 50 determines whether or not the user U has performed the specific action for each response to the request from the user U, based on the action-after-provision information that is collected by the collection unit 35.

The characteristic determination processing unit 51 determines the characteristic of the user U based on one or both of the request from the user U and the attribute of the user U. The characteristic determination processing unit 51 vectorizes, for example, requests (details of the requests) from the plurality of users U, and clusters a plurality of vectors that are obtained by the vectorization, so that it is possible to classify the vector of each of the users U into a corresponding class among a plurality of classes. In this case, the class into which the vector of the request from the user U is classified is the characteristic of the user U.

Furthermore, the characteristic determination processing unit 51 may determine the attribute of the user U as the characteristic of the user U. For example, the attribute of the user U may be represented by, for example, a combination of a plurality of attribute items. For example, the attribute of the user U is represented by a combination of gender, an age, and an area of residence, and is represented as, for example, Male, 20s, living in Tokyo, Female, 30s, living in Fukuoka, Female, 10s, living in Osaka, or the like, but embodiments are not limited to this example.

Moreover, the characteristic determination processing unit 51 may determine, as the characteristic of the user U, a feature that is represented by a combination of the class into which the vector of the request from the user U is classified and the attribute of the user U.

The relationship determination processing unit 52 determines a specific relationship that is a relationship between the characteristic of the user U and whether or not a specific action is performed by the user U after the providing unit 34 provides the response to the user U. For example, the relationship determination processing unit 52 is able to determine the specific relationship that is the relationship between the characteristic of the user U and whether or not a specific action is performed by the user U after the providing unit 34 provides the response to the user U, based on a determination result that is obtained by the action determination processing unit 50 and a determination result that is obtained by the characteristic determination processing unit 51.

The relationship determination processing unit 52 may determine, for example, an implementation rate (for example, a conversion rate) of the specific action for each characteristic of the user U as the specific relationship. In this case, the relationship determination processing unit 52 stores information indicating the implementation rate of the specific action for each characteristic of the user U, as the specific relationship information, in the storage unit 11.

Furthermore, the relationship determination processing unit 52 may determine, as the specific relationship, a combination of the characteristic of the user U and implementation or non-implementation of the specific action for each characteristic of the user U. In this case, the relationship determination processing unit 52 stores information indicating information in which the characteristic of the user U and implementation or non-implementation of the specific action are associated for each characteristic of the user U, as the specific relationship information, in the storage unit 11.

### 4. Flow of Process

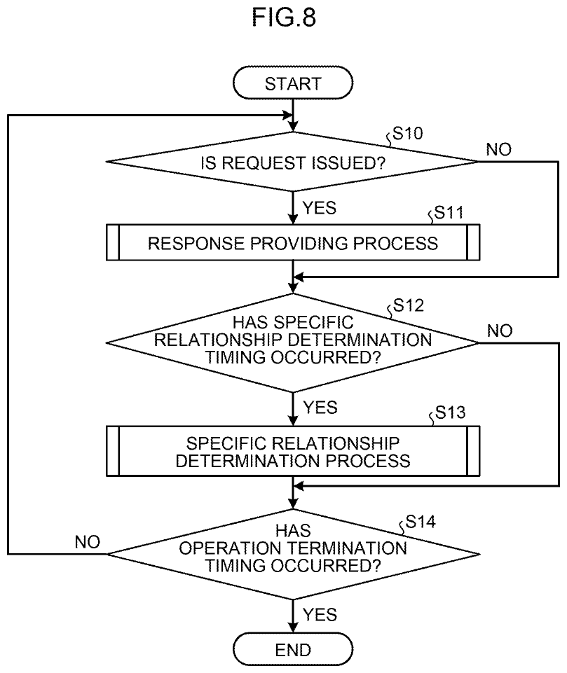

A flow of information processing that is performed by the processing unit 12 of the information processing apparatus 1 according to one embodiment will be described below. FIG. 8 is a flowchart illustrating the flow of the information processing that is performed by the processing unit 12 of the information processing apparatus 1 according to one embodiment.

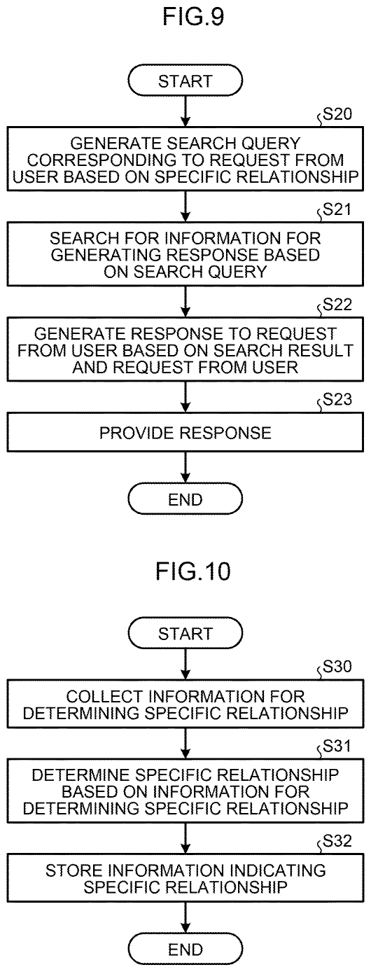

As illustrated in FIG. 8, the processing unit 12 of the information processing apparatus 1 determines whether or not a request is issued from the user U (Step S10). When determining that the request is issued from the user U (Step S10: Yes), the processing unit 12 performs a response providing process (Step S11). The response providing process at Step S11 includes processes from Step S20 to Step S23 illustrated in FIG. 9, and will be described in detail later.

When the process at Step S11 is terminated or when it is determined that the request is not issued from the user U (Step S10: No), the processing unit 12 determines whether or not a specific relationship determination timing has occurred (Step S12). The specific relationship determination timing is, for example, a timing that occurs at intervals determined in advance or a timing that is designated by an operator of the information processing apparatus 1 when the number of requests from the user U reaches a predetermined number, but embodiments are not limited to this example.

When determining that the specific relationship determination timing has occurred (Step S12: Yes), the processing unit 12 performs a specific relationship determination process (Step S13). The specific relationship determination process at Step S13 includes processes from Step S30 to Step S32 illustrated in FIG. 10, and will be described in detail later.

When the process at Step S13 is terminated or when it is determined that the specific relationship determination timing has not occurred (Step S12: No), the processing unit 12 determines whether or not an operation termination timing has occurred (Step S14). The processing unit 12 determines that the operation termination timing has occurred when, for example, a power of the information processing apparatus 1 is turned off or when it is determined that termination operation is performed by operation on an operation unit (not illustrated) of the information processing apparatus 1.

When determining that the operation termination timing has not occurred (Step S14: No), the processing unit 12 goes to the process at Step S10, and, when determining that the operation termination timing has occurred (Step S14: Yes), the processing unit 12 terminates the process illustrated in FIG. 8.

FIG. 9 is a flowchart illustrating an example of the response providing process that is performed by the processing unit 12 of the information processing apparatus 1 according to one embodiment. As illustrated in FIG. 9, the processing unit 12 generates a search query corresponding to the request from the user U based on the specific relationship (Step S20), and searches for information for generating a response based on the generated search query (Step S21).

Subsequently, the processing unit 12 generates a response to the request from the user U based on a search result obtained at Step S21 and the request from the user U (Step S22). The processing unit 12 provides the response generated at Step S22 to the user U (Step S23), and terminates the process illustrated in FIG. 9.

FIG. 10 is a flowchart illustrating an example of the specific relationship determination process that is performed by the processing unit 12 of the information processing apparatus 1 according to one embodiment. As illustrated in FIG. 10, the processing unit 12 collects information for determining a specific relationship from an external apparatus or the like (Step S30).

Subsequently, the processing unit 12 determines the specific relationship based on the information that is collected at Step S30 and that is for determining the specific relationship (Step S31). The processing unit 12 stores information indicating the specific relationship determined at Step S31 in the storage unit 11 (Step S32), and terminates the process illustrated in FIG. 10.

### 5. Modification

In the examples as described above, a case has been described in which the request from the user U is mainly a question and the response to the request from the user U is mainly an answer; however, the request from the user U may be a post that is made on an SNS by the user U, and the response to the request from the user U may be a repost on the SNS. Further, the request from the user U may be a browsing request for a certain content, such as a news article, and the response to the request from the user U may be a content that corresponds to the browsing request.

Furthermore, in the examples as described above, it is explained that the specific relationship is a relationship between the characteristic of the user U and whether or not a specific action related to the response is performed by the user U after the response is provided to the user U, but embodiments are not limited to this example. For example, it may be possible to adopt a relationship among the characteristic of the user U, a response to the request from the user U, and whether or not a specific action related to the response is performed by the user U after the response is provided to the user U.

In this case, the generation unit 33 may generate a response to the user U by adopting, as the response generation information, a response that is associated with top k specific actions (k is an integer equal to or larger than one) with the highest implementation rates that are associated, as the specific relationship, with the characteristic of the user U whose request is received by the reception unit 30.

Moreover, it is assumed that there is no specific action for which the implementation rate that is associated, as the specific relationship, with the characteristic of the user U whose request is received by the reception unit 30 is equal to or larger than a threshold. In this case, the query generation processing unit 40 may generate input information (prompt) that includes an instruction text for instructing not to include information on all of specific actions for which implementation rates that are associated, as the specific relationship, with the characteristic of the user U is not zero.

Furthermore, the query generation processing unit 40 determines that n or more specific actions that are associated, as the specific relationship, with the same characteristic as or a similar characteristic to the characteristic of the user U whose request is received by the reception unit 30 are not implemented. In this case, the query generation processing unit 40 may generate input information (prompt) that includes an instruction text for instructing not to include information on implementation of the n or more specific actions that are associated, as the specific relationship, the same characteristic as or a similar characteristic to the characteristic of the user U whose request is received by the reception unit 30.

Moreover, in the examples as described above, the processes that are performed by the processing unit 12 of the information processing apparatus 1 are explained; however, a part or whole of the processing unit 12 of the information processing apparatus 1 may be implemented by the terminal apparatus 2. When a part of the processing unit 12 of the information processing apparatus 1 is implemented by the terminal apparatus 2, the information processing apparatus 1 and the terminal apparatus 2 are examples of the information processing apparatus. Furthermore, when the whole of the processing unit 12 of the information processing apparatus 1 is implemented by the terminal apparatus 2, the terminal apparatus 2 is one example of the information processing apparatus.

Moreover, when the specific relationship is not generated, when a specific action indicating implementation of the specific action is absent, or when a specific action for which the implementation rate is equal to or larger than a threshold is absent, the query generation processing unit 40 may generate a search query without using the specific relationship information. In this case, the query generation processing unit 40 generates, for example, input information (prompt) that includes the request (details of the request) from the user U and an instruction text for instructing generation of a search query for searching for information for generating a response to the request from the user U, and inputs the generated input information to generative AI.

### 6. Hardware Configuration

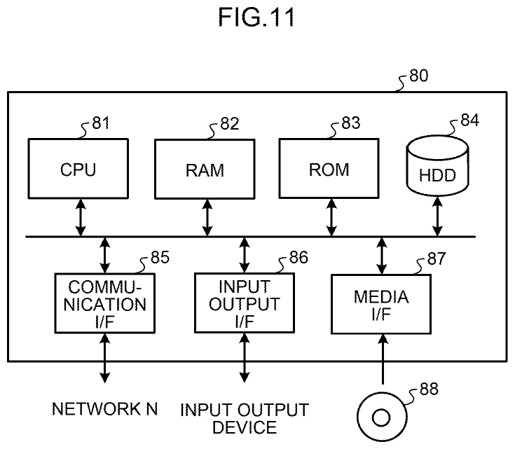

The information processing apparatus 1 according to one embodiment as described above is implemented by, for example, a computer 80 that is configured as illustrated in FIG. 7. FIG. 11 is a diagram illustrating an example of a hardware configuration of the computer 80 that implements the functions of the information processing apparatus 1 according to one embodiment. The computer 80 includes a CPU 81, a RAM 82, a Read Only Memory (ROM) 83, a Hard Disk Drive (HDD) 84, a communication interface (I/F) 85, an input output interface (I/F) 86, and a media interface (I/F) 87.

The CPU 81 operates based on a program that is stored in the ROM 83 or the HDD 84, and controls each of units. The ROM 83 stores therein a boot program that is executed by the CPU 81 at the time of activation of the computer 80, a program that is dependent on hardware of the computer 80, or the like.

The HDD 84 stores therein a program that is executed by the CPU 81, data that is used by the program, or the like. The communication interface 85 receives data from a different apparatus via the network N (see FIG. 2), sends the data to the CPU 81, and transmits data generated by the CPU 81 to a different apparatus via the network N.

The CPU 81 controls an output device, such as a display or a printer, and an input device, such as a keyboard or a mouse, via the input output interface 86. The CPU 81 acquires data from the input device via the input output interface 86. Further, the CPU 81 outputs generated data to the output device via the input output interface 86.

The media interface 87 reads a program or data that is stored in a recording medium 88, and provides the program or the data to the CPU 81 via the RAM 82. The CPU 81 loads the program from the recording medium 88 onto the RAM 82 via the media interface 87, and executes the loaded program. The recording medium 88 may be, for example, an optical recording medium, such as a Digital Versatile Disc (DVD) or a Phase change rewritable Disk (PD), a magneto-optical recording medium, such as a Magneto-Optical disk (MO), a tape medium, a magnetic recording medium, a semiconductor memory, or the like.

For example, when the computer 80 functions as the information processing apparatus 1 according to one embodiment, the CPU 81 of the computer 80 executes a loaded program and implements the functions of the processing unit 12. Further, the data in the storage unit 11 is stored in the HDD 84. The CPU 81 of the computer 80 reads the program as described above from the recording medium 88 and executes the read program; however, as another example, it may be possible to acquire the program from a different apparatus via the network N.

### 7. Others

Of the processes described in the embodiments as described above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, the information processing apparatus 1 as described above may be implemented by a terminal apparatus and a server computer or may be implemented by a plurality of server computers. Furthermore, some of the functions may be implemented by calling an external platform or the like by API, network computing, or the like. Thus, it is possible to flexibly change the configuration.

Furthermore, the embodiments and the modifications as described above may be appropriately combined as long as processes do not conflict with each other.

### 8. Effects

As described above, the information processing apparatus 1 according to one embodiment includes the reception unit 30, the search unit 32, and the generation unit 33. The reception unit 30 receives a request from the user UB. The user UB is one example of a first user. The search unit 32 searches for information for generating a response to a request from the user UB based on a relationship between a characteristic of the user UA and whether or not a specific action related to a response to a past request from the user UA is performed by the user UA after provision of the response. The user UA is one example of a second user. The generation unit 33 generates the response to the request from the user UB based on a search result that is obtained by the search unit 32 and the request from the user UB. With this configuration, the information processing apparatus 1 is able to use the action of the user U to whom the response to the request is provided.

Furthermore, the search unit 32 includes the query generation processing unit 40 and the search processing unit 41. The query generation processing unit 40 generates a search query for searching for the information for generating the response to the request from the user UB based on a relationship between the characteristic of the user UA and whether or not a specific action related to a response to a past request from the user UA is performed by the user UA after provision of the response. The search processing unit 41 searches for the information for generating the response to the request from the user UB by using the search query that is generated by the query generation processing unit 40. With this configuration, the information processing apparatus 1 is appropriately use the action of the user U to whom the response to the request is provided.

Moreover, the generation unit 33 generates the response to the request from the user UB by using generative AI. With this configuration, the information processing apparatus 1 is able to accurately use an action of the user U to whom the response to the request is provided.

Furthermore, the request includes a question in an online service. With this configuration, the information processing apparatus 1 is able to more appropriately use an action of the user U to whom an answer to the question in the online service is provided.

Moreover, the response includes information indicating a proposal to the user UB. It is possible to more appropriately use an action of the user U to whom the information indicating a proposal to the user U is provided.

Furthermore, the specific action is conversion corresponding to the response. With this configuration, the information processing apparatus 1 is able to more appropriately use an action of the user U to whom the response to the request is provided.

Moreover, the information processing apparatus 1 includes the collection unit 35 and the determination unit 36. The collection unit 35 collects action-after-provision information that indicates an action of the user UA after provision of the response to the user UA. The determination unit 36 determines the relationship based on the information that is collected by the collection unit 35. With this configuration, the information processing apparatus 1 is able to more appropriately use an action of the user U to whom the response to the request is provided.

Furthermore, the query generation processing unit 40 generates the search query by using generative AI. With this configuration, the information processing apparatus 1 is able to more appropriately use an action of the user U to whom the response to the request is provided.

Moreover, the generation unit generates a response to a request from the user UB by using generative AI. With this configuration, the information processing apparatus 1 is able to more appropriately use an action of the user U to whom the response to the request is provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

Furthermore, a “unit (section, module, or unit)” described above may be replaced with a “means” or a “circuitry”. For example, the acquisition unit may be replaced with an acquisition means or an acquisition circuitry.

What is claimed is:

1. An information processing apparatus comprising:
a reception unit that receives a request;
a search unit that searches for information for generating a response to a request from a first user based on a relationship between a characteristic of a second user and whether or not a specific action related to a response to a past request from the second user is performed by the second user after provision of the response; and
a generation unit that generates a response to a request from the first user based on a search result that is obtained by the search unit and the request from the first user.

2. The information processing apparatus according to claim 1, wherein the search unit includes
a query generation processing unit that generates a search query for searching for information for generating a response to a request from the first user based on a characteristic of the second user and whether or not a specific action related to a response to a past request from the second user is performed by the second user after provision of the response; and
a search processing unit that searches for information for generating a response to a request from the first user by using the search query that is generated by the query generation processing unit.

3. The information processing apparatus according to claim 1, wherein the generation unit generates a response to a request from the first user by using generative AI.

4. The information processing apparatus according to claim 1, wherein the request includes a question in an online service.

5. The information processing apparatus according to claim 1, wherein the response includes information indicating a proposal to the first user.

6. The information processing apparatus according to claim 1, wherein the specific action is conversion corresponding to the response.

7. The information processing apparatus according to claim 1, further comprising:
a collection unit that collects action-after-provision information that indicates an action of the second user after provision of the response to the second user; and
a determination unit that determines the relationship based on the action-after-provision information that is collected by the collection unit.

8. The information processing apparatus according to claim 2, wherein the query generation processing unit generates the search query by using generative AI.

9. An information processing method that is implemented by a computer, the information processing method comprising:
receiving a request from a first user;
searching for information for generating a response to a request from the first user based on a relationship between a characteristic of a second user and whether or not a specific action related to a response to a past request from the second user is performed by the second user after provision of the response; and
generating a response to a request from the first user based on a search result that is obtained at the searching and the request from the first user.

10. A non-transitory computer readable storage medium having an information processing program stored thereon, wherein the program instructs a computer to execute:
receiving a request from a first user;
searching for information for generating a response to a request from the first user based on a relationship between a characteristic of a second user and whether or not a specific action related to a response to a past request from the second user is performed by the second user after provision of the response; and
generating a response to a request from the first user based on a search result that is obtained at the searching and the request from the first user.
